(19) United States
(12) Patent Application Publication
(10) Pub. No.: US 2010/0017965 A1
(43) Pub. Date: Jan. 28, 2010

(54) HOSPITAL BED HAVING A LOCALLY REINFORCED FRAME

(76) Inventor: Hans-Peter Barthelt, Esslingen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 12/532,052

(22) PCT Filed: Feb. 12, 2008
(86) PCT No.: PCT/EP08/01050

§ 371 Date: Sep. 18, 2009

(30) Foreign Application Priority Data
Mar. 21, 2007 (DE) 10 2007 014 101.9

(51) Int. Cl. A61G 7/012; A61G 7/018; A61G 7/015; A61G 7/05

(52) U.S. Cl. 5/611

(57) ABSTRACT

A hospital bed having longitudinal rails, between which levers are supported. The levers are fixed on an axle tube that extends between the two longitudinal rails. The longitudinal rails are locally reinforced with respect to their wall thickness on the side situated adjacent to the axle tube by means of reinforcing plates welded thereto. A round rod extends through through-holes in the two longitudinal rails and the axle tube. For this purpose, the longitudinal rails are provided with through-holes that extend through the reinforcing plate.

### CROSS-REFERENCE TO RELATED APPLICATIONS

This patent application is the national phase of PCT/EP2008/001050, filed Feb. 12, 2008, which claims the benefit of German Patent Application No. 102007014101.9, filed Mar. 21, 2007.

### FIELD OF THE INVENTION

The present invention relates generally to hospital beds, and more particularly to hospital beds that are convertible from a normal bed position into a sitting chair position.

### BACKGROUND OF THE INVENTION

Hospital beds are typically composed of a floor-standing lifting mechanism on which a bed frame is arranged. The lifting mechanism makes it possible to adjust the height of the bed frame from a normal bed height to a nursing height so that patient care administered by the nursing staff is simplified. The actual bed frame is divided into several sections that can be moved relative to one another in order to elevate the individual body sections to a greater or lesser extent.

Due to such multiple pivoting and moving functions within the hospital bed, there still remains the recurring problem of rotatably supporting an axle or shaft between two longitudinal rails. The longitudinal rails of hospital beds usually consist of steel tubes with a rectangular cross section, which, for reasons of strength with respect to the load, are used upright. The steel tube has thin walls and its dimensions are defined in consideration of the bending strength under load.

A known method of supporting axles or shafts between such longitudinal rails is to drill through the steel tube and to insert a bushing into the hole thereby produced. The bushing is welded to the steel tube on both sides, wherein the surface on the side of the axle or shaft, i.e., the support side, must be also smoothed by grinding. Naturally, this also affects the welding seam.

A cylindrical bolt that protrudes from the frame tube into the axle or shaft after the installation is driven into the bearing bushing. In order to ensure that the bolt is retained in the bearing bushing, it is provided with knurling in the region that is located in the bearing bushing after the installation. This knurling is intended to form ridges that increase the outside diameter of the bolt. When the bolt is driven into the bearing bushing, the ridges produced by the knurling become wedged in the bearing bushing and retain the bolt. However, it has been found that such mounting method is reliable only if the components are manufactured with very strict tolerances. During the rotation of the axles, a rotating load occurs that results in compression of the joint between the bolt and the bushing, which causes the material to creep in the region of the knurling so that the bolt becomes loose.

### OBJECTS AND SUMMARY OF THE INVENTION

In light of the foregoing, it is an object of the invention to provide a hospital bed in which the axles are supported in a relatively simple manner between rectangular tubes that form the longitudinal rail.

In an embodiment of the invention, the hospital bed has a lifting mechanism that stands on the floor and can be adjusted with respect to its height. A bed frame that accommodates the mattress is disposed on the upper end of the lifting mechanism. Depending on the intended use, the bed frame is divided into a number of different sections that can be moved relative to one another. At least the lifting mechanism or an additional intermediate frame inserted between the lifting mechanism and the bed frame includes longitudinal rails in the form of rectangular tubes that extend in the longitudinal direction. At least one tubular axle or shaft is rotatably supported between these longitudinal rails.

In the region of the tubular axle or shaft, the rectangular tube or longitudinal rail is provided with a reinforcing plate on the side located adjacent to the axle or shaft. A through-hole extends through the longitudinal rail at the corresponding location. This hole is divided into two sections, namely an outer section in an outer tube wall of the longitudinal rail and an inner section in an inner tube wall adjacent reinforcing plate. A round rod extends through the mutually aligned sections of each through-hole of the two parallel longitudinal rails. The axle or shaft is supported on these two round rod sections.

It will be appreciated that such support no longer requires the welded bushing according to the state of the art that until now fulfilled two functions, i.e., the retention of the inserted bearing bolt and the transmission of the load in the longitudinal rails.

The wall thickness of the tubular longitudinal rails is primarily chosen in accordance with the bending forces that occur under the normal operating load of the hospital bed. However, forces that are much higher can occur locally due to the axle or shaft because the surface pressure is excessively high. Due to the utilization of the reinforcing plate, the surface is enlarged to such an extent in this critical region that the round rod itself, which is seated in the hole, neither has a tendency to creep nor causes creeping on the wall of the hole.

The new connecting method is furthermore can be carried out with greater tolerances because the round rod can be seated in the through-hole with play. Knurling, which is difficult to produce and subject to strict tolerances, as well as the subsequent processing of the welded bearing bushing on the bearing side, is no longer required.

If a single round rod is used that extends through both rails and the axle/shaft, particularly favorable conditions with respect to the bending load of the round rod are realized because a freely projecting inner end, as occurs with driven-in knurled bolts, is avoided. The round rod is clamped in position on both ends and does not project freely on one end like a knurled bolt. This also reduces the load on the edge of the through-hole because the bending strength reduces tilting of the round rod in the through-hole. Consequently, the outer section of the through-hole is also used for the support such that the surface pressure on the bearing side is significantly reduced.

In the hospital bed of the invention, the reinforcing plate provided on the bearing side functionally replaces the bearing bushing used thus far, i.e., the space between the two parallel walls of the longitudinal rails does not contain any other structural elements. Adequate load conditions are realized if the reinforcing plate is integrally connected to the respective surface of the longitudinal rail. The integral connection can be produced by soldering the reinforcing plate or by welding the reinforcing plate at its edges. The reinforcing plate may be square, for example, such that the orientation during the installation on the longitudinal rail is significantly simplified. An adequate load transfer to the reinforcing plate also is achieved if the through-hole is produced after attachment of the reinforcing plate.

In conventional hospital beds, the wall thickness of the tubular longitudinal rails is between 1.5 and 3 mm. In this case, it is advantageous if the reinforcing plate has a thickness between 2 and 8 mm, depending on the intensity of the radial load in the region of the through-hole.

An advantageous support of the axle or shaft on the round rod is realized if the ends of the tubular axle or shaft have reduction sleeves with openings adapted to the outside diameter of the round rod. With the aid of at least one frictionally engaged retaining ring, the round rod can be held so that it cannot be axially displaced.

The following description of the figures elucidates aspects for comprehending the invention. A person skilled in the art can conventionally gather details that are not described from the drawings that supplement the description of the figures in this respect. It should be clear that a number of modifications are possible.

The drawings described below are not necessarily true to scale. Certain regions may be greatly enlarged in order to emphasize certain details. Furthermore, the drawings are simplified and do not contain every detail that may be present in an actual embodiment. The terms “top” and “bottom,” “front” and “rear,” and “right” and “left” are relative to the normal operating position, as used in hospital bed terminology.

Other objects and advantages of the invention will become apparent upon reading the following detailed description and upon reference to the drawings, in which:

### BRIEF DESCRIPTION OF THE DRAWINGS

FIG. 1 is a perspective of an illustrative hospital be in accordance with the invention;

FIG. 2 is a depiction of the hospital bed shown in FIG. 1 adjusted to a chair or sitting position;

FIG. 3 is a front side elevation view of the bed frame of the bed shown in FIG. 1;

FIG. 4 is a fragmentary perspective of the floor frame of the lifting mechanism of the bed frame shown in FIG. 3 that provides an axel support; and

FIG. 5 is an exploded fragmentary view of the bearing arrangement of the axel support shown in FIG. 4.

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENTS

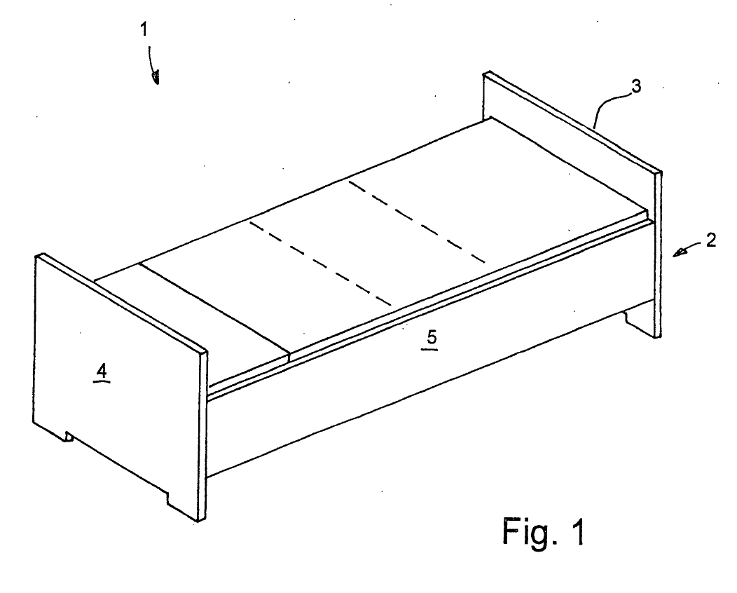

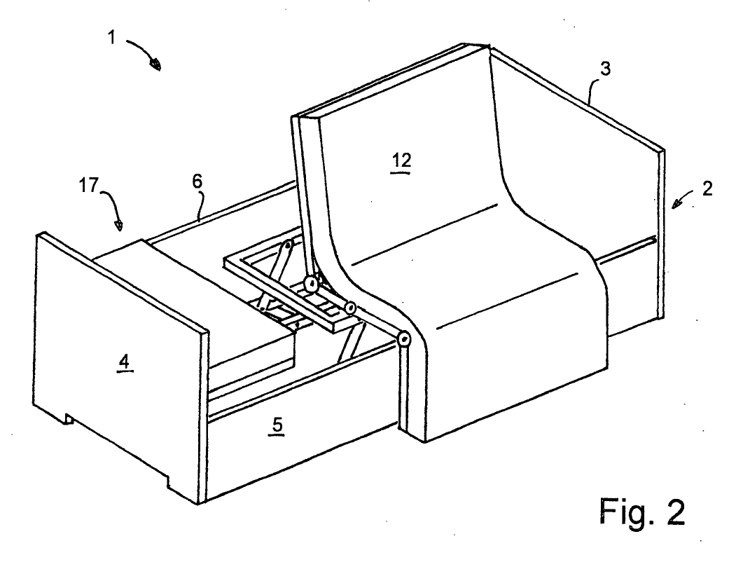

Referring now more particularly to the drawings, there is shown an illustrative hospital bed 1 in accordance with the invention, depicted in FIG. 1 in a sleeping position and in FIG. 2 in a sitting or chair position. A hospital bed 1 includes a bed border 2 with a head part 3, a foot part 4, and side walls 5,6. The side wall 5 facing the observer is in the sleeping position, in which it is spaced apart from the floor as shown such that a gap is formed between the lower edge of the side wall 5 and the floor so that nursing personnel are able to place the tips of their feet beneath the bed. The side wall 5 is movably supported for transfer into a position in which it is displaced downward, in the chair position of the hospital bed 1 as shown in FIG. 2. The moveable support of the side wall 5 is explicitly described, for example, in DE 199 12 937 A1.

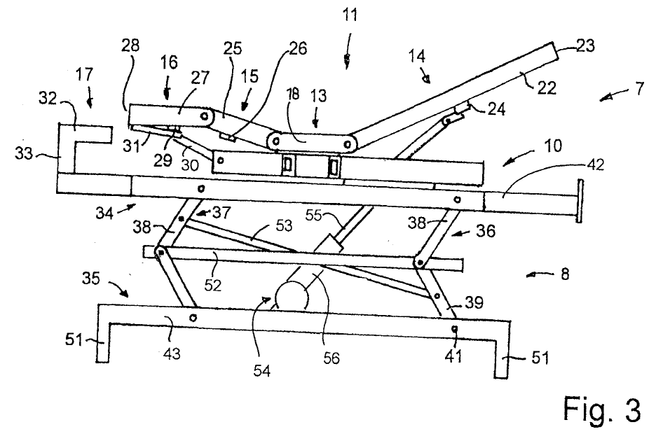

A bed frame 7 is located within the bed border 2, as depicted in FIG. 3. The bed frame 7 includes a height-adjustable base 8, on the upper side of which is mounted a rotary hinge with a vertical axis of rotation; an intermediate frame 10; and a bed frame 11, on which a mattress 12 is arranged. The bed frame 11 has a rectangular shape as viewed from the top. The rotary hinge is not visible in FIG. 3 because it is essentially sunk into the base 8.

The bed frame 11 is divided into a central section 13 that is rigidly connected to the intermediate frame 11, a back section 14 that is hinged to the central section 13, a thigh section 15 that is also hinged to the central section 13, and a lower leg section 16. The lower leg section 16 is hinged to the end of the thigh section 15 that lies opposite the central section 13. The hinge axes, about which the sections 14, 15, 16 can be moved relative to the central section 13, extend in the horizontal direction. The bed frame 11 also includes a foot section 17 that is rigidly connected to the base 8.

The central section 13 of the bed frame 12 includes two longitudinal rails 18 that extend parallel to one another, wherein only one of these longitudinal rails is visible due to the side view. The other longitudinal rail lies behind the visible longitudinal rail. Each of these rails 18 ends at a bracket for a hinge.

The back section 14 is bordered by a rail 22 and another rail that extends parallel thereto and that cannot be seen in FIG. 3 due to the illustration. The visible rail 22 is hinged to the rail 18. The two rails 22 of the back section 14 are connected to one another at the upper end 23 by means of an appropriate cross member (not shown in the figure). In addition, another cross brace 24 extends on the underside of the two rails 22 intermediate their ends.

The thigh section 15 is also bordered by two longitudinal rails 25, of which only one front longitudinal rail 25 is visible in the figure. The other longitudinal rail is aligned with the longitudinal rail 25. The two longitudinal rails 25 are connected by means of a cross brace 26, which extends approximately in the center of each longitudinal rail 25, i.e., on the underside.

The lower leg section 16 is also bordered by two longitudinal rails 27, only one of which is visible in FIG. 3. The two longitudinal rails 27 are connected to one another by means of a cross brace on the lower end at 28. The two longitudinal rails 27 are connected not only by the cross brace 28 but also by a brace 29, on which are fixed two parallel guide rails 31 that extend up to the lower cross brace 28. They extend at an angle relative to the longitudinal rails 27, as shown, such that they converge in the direction toward the foot end. The distance between the two guide rails 31 is significantly smaller than the distance between the two longitudinal rails 27, with the guide rails 31 being inwardly offset relative to the longitudinal rails 27 by approximately 20 cm. A lever arrangement 30 that makes it possible to raise the lower leg section 16 engages in the guide rails 31. The foot section 17 consists of rails 32 that are supported on the base 8 by means of braces 33.

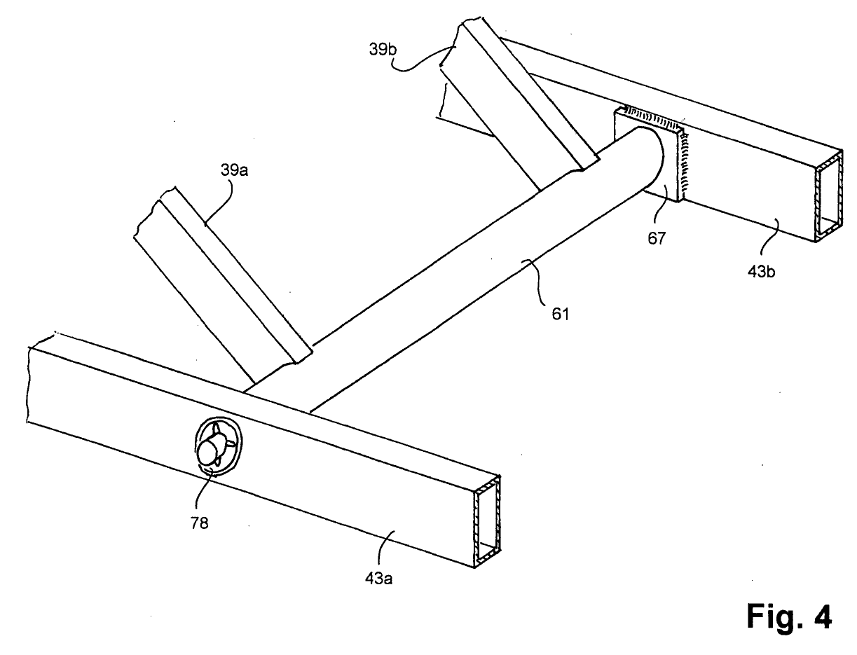

The height-adjustable base 8 includes an upper frame 34 and a lower frame 35 that are connected to one another by a total of five toggle lever pairs 36,37. The respective toggle lever pairs 36, 37 are located on a longitudinal side of the base 8 such that the corresponding toggle lever pairs 36, 37 on the other longitudinal side cannot be seen in the side view of FIG. 3. The toggle lever pairs are supported as shown in FIG. 4 and described in more detail below.

The toggle lever pairs 36, 37 each includes an upper toggle lever 38 and a lower toggle lever 39. Each toggle lever 38, 39 is respectively supported in the upper and lower frames 34, 35 by means of a bearing arrangement with horizontal bearing hinge axes. The bearing axes, which are schematically indicated at 41, extend axially parallel to one another. The bearing hinge axes 41 on the front side of the frame, as depicted in FIG. 3, lie coaxial to the axes 41 of the toggle levers 38, 39 (not visible) on the rear side.

The upper frame is laterally bordered by two longitudinal rails 42 that extend parallel to one another and are rigidly connected by means of cross braces (not visible). A rectangular frame structure is thereby formed. The lower frame is similarly composed of two longitudinal rails 43 that extend parallel to one another and are also rigidly connected by means of cross braces. The lower frame also forms a rigid rectangular frame structure.

The two toggle lever pairs 36, 37 on each side of the base 8 are respectively coupled to one another by means of a corresponding horizontal coupling brace 52. Each coupling brace 52 is articulatedly connected to the toggle link of each toggle lever pair 36,37 as shown. In addition, an obliquely extending coupling brace 53 connects the upper toggle lever 38 of the toggle lever pair 37 to the lower toggle lever 39 of the toggle lever pair 36 on each side of the base 8.

A drive motor 54 is disposed between the upper frame 34 and the lower frame 35, which may be a commercially available spindle motor. A worm gear pair (not shown), which is driven with the aid of a permanently excited motor 54, is connected to a jack screw without rotational play. A threaded nut, on which a lifting tube 55 is arranged in a tension- and compression-proof fashion, runs on the jack screw, wherein said lifting tube moves coaxially in a guide tube 56. As will be understood by a person skilled in the art, the lifting tube 55 is either retracted into the guide tube 56 or extended from the guide tube by starting the motor 54 in the corresponding direction of rotation. The upper frame 34 moves upward when the lifting tube 55 is extended.

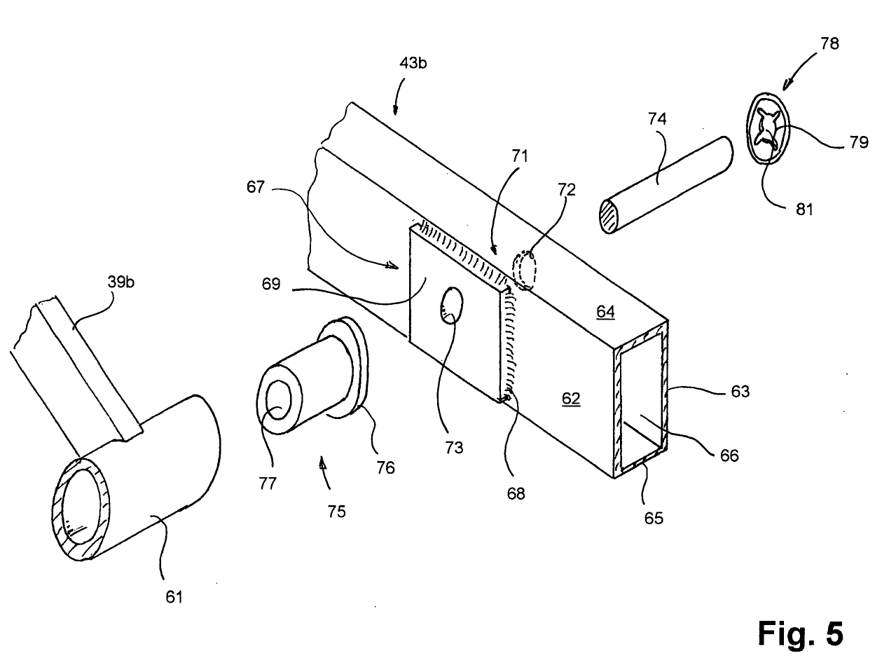

FIG. 4 shows the lower frame 35 of the lifting mechanism in detail. Since this figure also shows components that are depicted in FIG. 3, they are generally designated by the same reference symbols supplemented with the additional letters a and b in order to distinguish between the congruent parts situated on the right and left sides. FIG. 4 shows sections of the two lower longitudinal rails 43a,43b, between which the lower toggle levers 39a,39b of the toggle lever pair 36 are supported. The two toggle levers 39a,39b are arranged parallel to one another and welded to an axle tube 61 at a distance from one another. The axle tube 61 laterally protrudes beyond the two toggle levers 39a,39b as shown and between the two longitudinal rails 43a,43b. The design is more specifically depicted in FIG. 5, which shows a section of the longitudinal rail 39b,as well as part of the lower toggle lever 39b. The support at the longitudinal rail 43a is effected in the same way such that it suffices to describe the support on only one end of the axle tube 61.

The longitudinal rail 43b consists of a steel tube with rectangular cross section which is used upright for reasons of load support. The tube is closed in the circumferential direction and consists of a total of four plane walls 62, 63, 64 and 65 that extend parallel to one another in pairs and tubularly enclose a rectangular 65. For example, the walls 62,63 have a height of 50 mm while the walls 64,65 have a width between 20 and 30 mm. The wall thickness of the walls 62-65 is between 1.5 and 3 mm.

The wall 62 of the longitudinal rail 43b that faces the axle tube 61 is reinforced with respect to its thickness by means of a reinforcing plate 67 where the axle tube 61 is located. The reinforcing plate 67 consists of a plane-parallel steel plate with an edge length that approximately corresponds to the height of the wall 62. It is connected to the wall 62 on all peripheral sides by means of a welding seam 68. The edge length of the reinforcing plate 67 is chosen such that an intact plane surface 69 is provided that can serve as an axial bearing surface or a stopping face apart from the peripheral edge affected by the welding conditions.

In order to support the axle tube 61, a through-hole 71, which is composed of an outer section 72 in the wall 63 and an inner section 73 in the wall 62, and the reinforcing plate 67 extend through the longitudinal rail 43b. The two sections 72 and 73 have the same diameter. They are also exactly aligned with one another. This is achieved by forming the hole 71 after the reinforcing plate 67 has been welded on the inner side of the longitudinal rail 43b, i.e., on the bearing side.

The transmission of radial forces originating from the axle tube 61 is effected with a round rod 74, the outside diameter of which corresponds to the nominal diameter of the hole 71. The outside diameter of the round rod 74 is significantly smaller than the interior diameter of the axle tube 61. A diametral adaptation is effected by inserting a flanged sleeve 75 into the corresponding end of the axle tube 61, wherein the flanged sleeve carries a disk-shaped flange 76, the outside diameter “d” of which corresponds to the outside diameter of the axle tube 61. The outside diameter of the cylindrical section of the flanged sleeve 75 is adapted to the interior diameter of the axle tube 61 such that the flange sleeve 75 can be inserted into the axle tube 61 from its end with slight play or a tight fit. A hole 77 coaxially extends through the flanged sleeve 75.

In the installed state, the axle tube 61 with the toggle lever arms 39a,39b fixed thereon is arranged with slight axial play between the two reinforcing plates 67 that are welded to the parallel longitudinal rails 43a,43b. The outer planar side of the disk 76 of the flanged sleeve 65, which consists of polyamide, for example, is located opposite the plane surface 69 of the reinforcing plate 67.

The round rod 74 extends uninterruptedly through the axle tube 61, the hole 77 of the flanged sleeve 75 and the aligned holes 71 of the two longitudinal rails 43a,43b. On the side of the outer wall 63 of each of longitudinal rail 43a,43b, the round rod 74 protrudes by a short distance of approximately 10 to 15 mm.

In order to axially secure the round rod 74, a commercially available disk-shaped claw spring 78 is attached on each free end that protrudes beyond the respective side wall 63. This claw spring 78 has lugs 79 that are directed radially inward and define a hole 81, the diameter of which is smaller than the outside diameter of the round rod 74 when the claw spring 78 is relaxed. These claw springs are attached to the round rod 74 in such a way that they can no longer be removed from it without being destroyed.

In the illustrated embodiment, the two longitudinal rails 43a,43b are locally reinforced with respect to their wall thickness by means of the reinforcing plate 67 welded thereon, i.e., at the locations at which a radial force or sheer force is transmitted from the axle tube 61 to the corresponding longitudinal rail 43a, 43b. This creates a supporting surface in the region of the hole section 73, wherein this supporting surface is of sufficient size to transmit the forces without suffering long-term material deformations. On the other hand, the wall thickness of the respective longitudinal rail 43a or 43b can still be chosen in accordance with the occurring bending forces. It is not necessary to use a thicker material in order merely to transmit the radial bearing forces. A further improvement is achieved in that the round rod 74 is clamped into the longitudinal rails 43a,43b on both ends. Consequently, it is better able to transmit the forces directly on the exit side of the longitudinal rail 43b, such that its deflection is reduced.

The novel support has been explicitly depicted in FIGS. 4 and 5 for the support of the lower toggle lever arms 39a,39b of the toggle lever pair 36. However, a person skilled in the art will understand that the support can also be used for the lower toggle lever arms 39 of the toggle lever pair 37 and for the upper toggle lever arms 38 of the two toggle lever pairs 36,37, as well as for the lever spindle 30 that is supported in the intermediate frame that also consists of parallel longitudinal rails. Consequently, the design of the support described in connection with the toggle lever arms 39 of the toggle lever pair 36 is merely representative for all other comparable bearing points in the hospital bed 1.

Instead of using a single continuous round rod 74, it would also be possible to use short rod sections of such length that they extend through the flanged sleeve 75 in the installed state and carry a head similar to a nail on the outside of the longitudinal rail 43. The two-part round rod can be secured axially outward by means of a bridge retainer that is arranged on the outside of the longitudinal rail 43 and spans over this head.

From the foregoing, it can be seen that a hospital bed is provided that has longitudinal rails, between which levers are supported. The levers are fixed on an axle tube that extends between the two longitudinal rails. The longitudinal rails are locally reinforced with respect to their wall thickness at the axle tube, i.e., on the side adjacent to the axle tube, by means of reinforcing plates welded to it. A round rod extends through the through-holes in the two longitudinal rails and the axle tube. For this purpose, the longitudinal rails are provided with through-holes that extend through the reinforcing plate.

1-13. (canceled)

14. A hospital bed (1) comprising:
a lifting mechanism (8) supported on the floor that is adjustable in a vertical direction,
a bed frame (11) arranged on the lifting mechanism (8),
at least one of the lifting mechanism (8) or bed frame (11) includes two parallel longitudinal rails (42, 43) in the form of thin-walled rectangular tubes between which at least one tubular shaft (61) is arranged, said rectangular tubes each being formed with a through-hole (71) that is divided into two sections (72, 73) at the level of the shaft (61), one said section (72) being in a wall (63) of the rectangular tube (43) and the other section (73) being in an opposite wall (62) of the rectangular tube (43),
at least one round rod section (74) for supporting the respective shaft (61), said at least one round rod section (74) extending through the through-hole (71) of the respective rectangular tube (43) and into the shaft (61) such that the at least one round rod section (74) protrudes on an outer side (63) of the respective rectangular tube (43),
a reinforcing plate integrally fixed to each rectangular tube (43) on the side (62) that is located adjacent to the supported shaft (61) and through which the through-hole (71) extends such that said hole (71) extends through both the longitudinal rail (43) and the reinforcing plate (67).

15. The hospital bed of claim 14 in which a gap exists between the sections (72, 73) of each through-hole (71) without any structural element therein.

16. The hospital bed of claim 14 in which each through-hole (71) has the same diameter through the walls of the rectangular tube (43) and said reinforcing plate (67).

17. The hospital bed of claim 14 in which each through-hole (71) is formed after the reinforcing plate (67) is attached to the rectangular tube (43).

18. The hospital bed of claim 14 in which each rectangular tube (43) has a wall thickness of between 1.2 mm and 4 mm.

19. The hospital bed of claim 14 in which each reinforcing plate (67) has a thickness between 2 mm and 8 mm.

20. The hospital bed of claim 14 in which each said through-hole (71) has a diameter of between 5 mm and 15 mm.

21. The hospital bed of claim 14 in which said reinforcing plate (67) is square, and each side of the reinforcing plate (67) has an edge length smaller than a height of the longitudinal rail (43).

22. The hospital bed of claim 14 in which said reinforcing plate (67) is integrally connected to the longitudinal rail (43) at its peripheral edges.

23. The hospital bed of claim 14 in which each reinforcing plate (67) is welded to the longitudinal rail (43) at its peripheral edges.

24. The hospital bed of claim 14 in which said at least one round rod section (74) comprises two rod parts which each protrude outwardly beyond a respective side of one of the longitudinal rails (43).

25. The hospital bed of claim 24 in which said round rod parts (74) carry a retaining ring (78) on each end that protrudes outwardly beyond the longitudinal rails which axially retain the round rod parts within the through-hole (71).

26. The hospital bed of claim 14 including a reduction sleeves (75) disposed in each end of the tubular shaft (61), said reduction sleeve having an inside diameter (77) corresponding to the outside diameter of the round rod section (74).
